(19) United States
(12) Patent Application Publication
(10) Pub. No.: US 2015/0098802 A1
(43) Pub. Date: Apr. 9, 2015

(54) SHROUDED TURBINE BLISK AND METHOD OF MANUFACTURING SAME

(71) Applicant: General Electric Company, Schenectady, NY (US)

(72) Inventors: Thomas Joseph Farineau, Schoharie, NY (US); Robin Carl Schwant, Pattersonville, NY (US); Ganesh Krishnamoorthy, Schenectady, NY (US); Rajiv Sampath, Mason, OH (US)

(73) Assignee: General Electric Company, Scheneclady, NY (US)

(21) Appl. No.: 14/048,431

(22) Filed: Oct. 8, 2013

(51) Int. Cl. F01D 5/22; B23P 15/02

(52) U.S. Cl. CPC F01D 5/225; B23P 15/02
USPC 415/122.1; 416/182; 29/889.23

(57) ABSTRACT

Shrouded turbine blisks and methods of manufacturing same are provided. A shrouded turbine blisk includes a central disk portion including an axis of rotation, an inner rim, a plurality of airfoils that extends radially outwardly from the inner rim; and a shroud integrally coupled to each of the plurality of airfoils. The shroud includes a plurality of circumferentially-arranged arcuate shroud segments defined at least in part by gaps positioned between adjacent shroud segments. The central disk portion, the inner rim, the plurality of airfoils, and the shroud are defined from a single billet of blisk material.

### BACKGROUND OF THE INVENTION

The present disclosure relates generally to steam turbine engines, and, more particularly, to turbine blisks for use in steam turbine engines.

At least some known steam turbine engines include at least one stage that includes a disk from which circumferentially-spaced apart rotor blades extend radially outwardly. Each rotor blade includes an airfoil and a dovetail at its root, with the dovetail being radially retained in a complementary slot in the perimeter of the disk. During operation, the disk and blades attached thereto rotate, with the blades developing substantial centrifugal force which is carried downwardly through the respective dovetails and into the disk. The dovetails must be suitably configured and sized for supporting the blades with a suitably low level of stress for obtaining a useful life in operation.

In some known steam turbine engines, the blades are spaced relatively closely together around the perimeter of the disk, which results in the inability of conventional dovetail designs to carry centrifugal loading at suitable levels of stress to enable the disk to have a useful service life. Other design considerations likewise may present challenges in using conventional dovetail designs. Accordingly, in at least some known steam turbine engines, the airfoils are manufactured integrally with the disk as a one-piece component conventionally known as a blisk (from “bladed disk”). Blisks are also sometimes referred to as integrally-bladed rotors. A blisk is typically manufactured from a one piece solid forging which is subsequently conventionally machined, for example, using either a mill or electrochemical machining (ECM) electrodes. With the blades being integral with the disk, satisfactory levels of stress capacity may be obtained in the blisk during operation for obtaining a useful service life.

In at least some known blisk configurations, a continuous mid-span or part-span shroud is provided that bifurcates the airfoils into inner, or hub, airfoils and outer, or tip, airfoils such that airflow is channeled separately thereover in different inner and outer flowpaths. The continuous shroud not only facilitates precluding radial cross flow or leakage between the inner and outer flow paths but also facilitates substantially increasing the overall stiffness of the blisk to raise its vibrational frequencies into a more desirable range. Moreover, the additional mass provided by the shroud itself also generates centrifugal loads during operation which in part are carried through hoop stresses generated in the shroud during operation. Some of the shroud centrifugal loads, however, are also carried through the inner airfoils to the disk.

However, such blisk configurations still leave radially outermost tips of the airfoils uncovered, requiring the use of static shrouds that surround the blisk. Accordingly, it is desirable to provide a blisk construction that addresses the issue of uncovered airfoil tips. It is also desirable to provide a blisk construction that addresses hoop stresses generated by shroud components that are coupled to the airfoils.

### BRIEF DESCRIPTION OF THE INVENTION

In an aspect, a method for manufacturing a turbine blisk is provided. The method includes providing a solid circular billet of blisk material, the billet including an axis of rotation. The method also includes defining an inner rim that extends circumferentially about the axis of rotation and encircling a central disk portion. The method also includes defining a plurality of airfoils that extends radially outwardly from the inner rim. The method also includes defining a shroud integrally coupled to each of the plurality of airfoils, wherein the shroud includes a plurality of circumferentially-arranged arcuate shroud segments defined at least in part by gaps positioned between adjacent shroud segments.

In another aspect, a turbine blisk for use in a turbine engine is provided. The turbine blisk includes a central disk portion including an axis of rotation. The turbine blisk also includes an inner rim that extends circumferentially about the axis of rotation and encircling the central disk portion. The turbine disk also includes a plurality of airfoils that extends radially outwardly from the inner rim. The turbine disk also includes a shroud integrally coupled to each of the plurality of airfoils, wherein the shroud includes a plurality of circumferentially-arranged arcuate shroud segments defined at least in part by gaps positioned between adjacent shroud segments. The central disk portion, the inner rim, the plurality of airfoils, and the shroud are defined from a single billet of blisk material.

In another aspect, a turbine system is provided. The turbine system includes a source of steam. The turbine system also includes a steam turbine coupled to the source of steam, wherein the steam turbine includes at least one turbine blisk coupled to an output shaft for rotation about an axis. The turbine system also includes a load coupled to the output shaft. The turbine blisk includes a central disk portion including an axis of rotation. The turbine blisk also includes an inner rim that extends circumferentially about the axis of rotation and encircling the central disk portion. The turbine blisk also includes a plurality of airfoils that extends radially outwardly from the inner rim. The turbine blisk also includes a shroud integrally coupled to each of the plurality of airfoils, wherein the shroud includes a plurality of circumferentially-arranged arcuate shroud segments defined at least in part by gaps positioned between adjacent shroud segments, wherein the central disk portion, the inner rim, the plurality of airfoils, and the shroud are defined from a single billet of blisk material.

### BRIEF DESCRIPTION OF THE DRAWINGS

FIG. 1 is a schematic illustration of an exemplary steam turbine engine.

FIG. 2 is a front plan view of a turbine blisk that may be used in the steam turbine engine illustrated in FIG. 1.

FIG. 3 is a side-sectional view of the turbine blisk illustrated in FIG. 2, taken along line 3-3 of FIG. 2.

FIG. 4 is a top perspective view of a portion of the turbine blisk illustrated in FIG. 2.

### DETAILED DESCRIPTION OF THE INVENTION

As used herein, the terms “axial” and “axially” refer to directions and orientations that extend substantially parallel to a longitudinal axis of a steam turbine engine. Moreover, the terms “radial” and “radially” refer to directions and orientations that extend substantially perpendicular to the longitudinal axis of the steam turbine engine. In addition, as used herein, the terms “circumferential” and “circumferentially” refer to directions and orientations that extend arcuately about the longitudinal axis of the steam turbine engine. It should also be appreciated that the term “fluid” as used herein includes any medium or material that flows, including, but not limited to, gas and air.

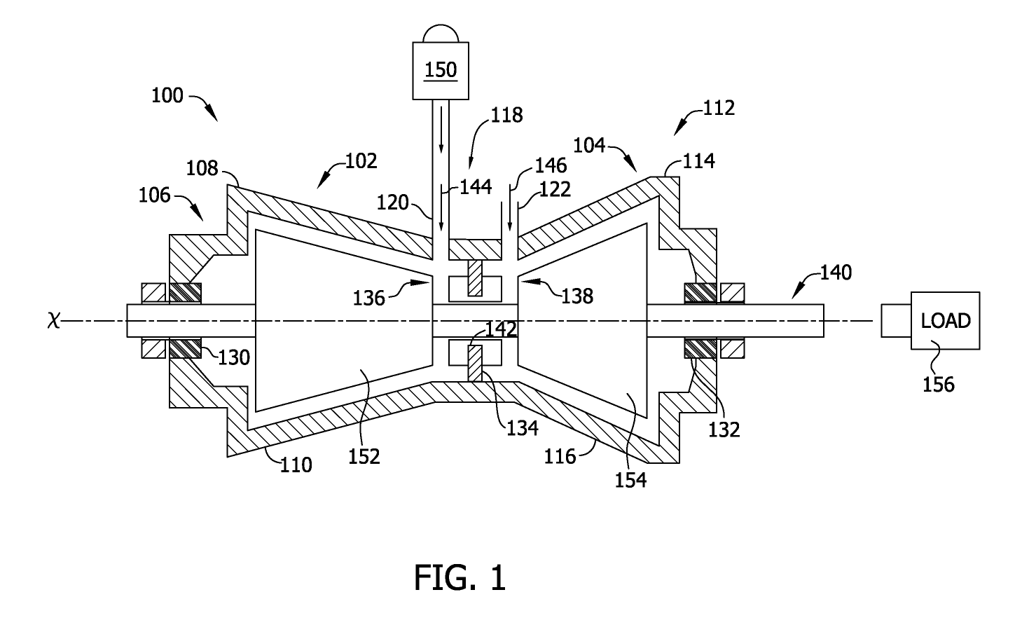

FIG. 1 is a schematic illustration of an exemplary steam turbine engine 100. Engine 100 includes a high-pressure (HP) section 102 and an intermediate-pressure (IP) section 104. An HP shell, or casing, 106 is divided axially into upper and lower half sections 108 and 110, respectively. Similarly, an IP shell 112 is divided axially into upper and lower half sections 114 and 116, respectively. In the exemplary embodiment, shells 106 and 112 are inner casings. Alternatively, shells 106 and 112 are outer casings. In the exemplary embodiment, shells 106 and 112 are sealed such that ambient air is not admitted into engine 100. A central section 118 is positioned between HP section 102 and IP section 104 and includes a high-pressure steam inlet 120 and an intermediate-pressure steam inlet 122.

An annular section divider 134 extends radially inwardly from central section 118 towards a rotor shaft 140 that extends between HP section 102 and IP section 104, and is configured for rotation about an axis X. Rotor shaft 140 is supported for rotation by bearings 130 and 132. More specifically, divider 134 extends circumferentially around a portion of rotor shaft 140 between a first HP section inlet nozzle 136 and a first IP section inlet nozzle 138. Divider 134 is received in a channel 142.

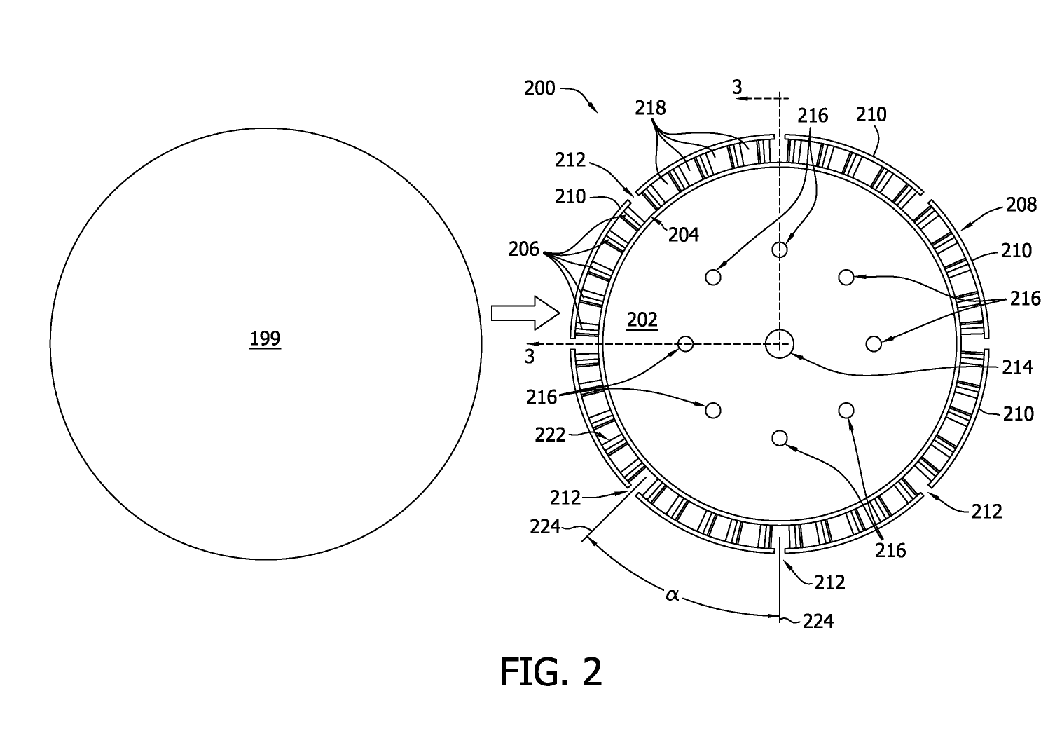

During operation, high-pressure steam inlet 120 receives high-pressure/high-temperature steam 144 from a steam source 150, for example, a power boiler. Steam 144 is routed through HP section 102 from inlet nozzle 136 wherein work is extracted from the steam 144 to rotate rotor shaft 140 via one or more bladed rotors 152, 154 that are coupled to shaft 140. Bladed rotors 152, 154 include a plurality of turbine airfoils (also referred to as blades or buckets) 206 (shown in FIGS. 2-4). Steam 144 exits HP section 102 and is returned to the boiler wherein it is reheated. Reheated steam 146 is then routed to intermediate-pressure steam inlet 122 and returned to IP section 104 via inlet nozzle 138 at a reduced pressure than steam 144 entering HP section 102, but at a temperature that is approximately equal to the temperature of steam 144 entering HP section 102. Work is extracted from the steam 146 in IP section 104 in a manner substantially similar to that used for HP section 102 via a system of rotating and stationary components. According, an operating pressure within HP section 102 is higher than an operating pressure within IP section 104, such that steam 144 within HP section 102 is higher than an operating pressure within IP section 104. In the exemplary embodiment, the extracted work causes shaft 140 to rotate. Shaft 140 is coupled to a load 156, such as an electrical generator.

In the exemplary embodiment, steam turbine engine 100 is an opposed-flow high-pressure and intermediate-pressure steam turbine combination. Alternatively, steam turbine engine 100 may be used with any individual turbine including, but not limited to, low-pressure turbines. In addition, the present invention is not limited to being used with opposed-flow steam turbines, but rather may be used with other steam turbine configurations that include, but are not limited to, single-flow and double-flow turbine steam turbines.

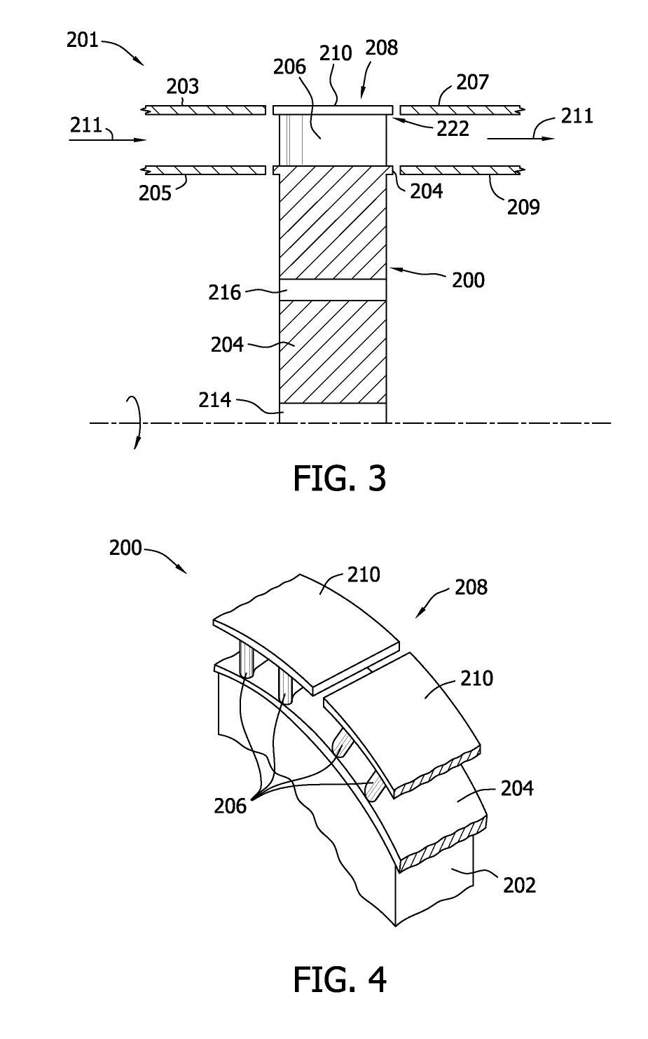

FIG. 2 is a front plan of a turbine blisk 200 that may be used with steam turbine engine 100 illustrated in FIG. 1. FIG. 3 is a side sectional view of turbine blisk 200 illustrated in FIG. 2, taken along line 3-3 of FIG. 2. Blisk 200 includes a central disk portion 202 surrounded by an inner rim 204. A plurality of airfoils 206 extends radially outwardly from inner rim 204 at regularly-spaced intervals around the circumference of inner rim 204. A plurality of passages 218 is defined between adjacent airfoils 206. A shroud 208 is defined by a plurality of arcuate shroud segments 210 separated by gaps 212. In the exemplary embodiment, blisk 200 includes any number of airfoils 206 that enables blisk 200 to function as described herein, as long as an even number of airfoils 206 is provided, for facilitating dynamic balancing of blisk 200. Each airfoil 206 includes a radially outboard tip 222.

A central shaft aperture 214 is concentrically defined within central disk portion 202. Aperture 214 is encircled by a plurality of fastener apertures 216. While eight apertures 216 are illustrated in FIG. 2, in alternative exemplary embodiments any number of apertures 216 is provided that enables blisk 200 to function as described herein. Shaft aperture 214 is configured to receive a drive shaft (not shown), for facilitating rotation of blisk 200 around an axis 220 (illustrated in FIG. 3). Fastener apertures 216 facilitate coupling of blisk 200 to other structures (not shown), such as spacers used in at least some known steam turbine engines.

FIG. 3 further illustrates a side sectional view of blisk 200, as oriented within an exemplary turbine engine 201. Turbine engine 201 includes static fluid channeling structures 203 and 205, and 207 and 209, respectively, which cooperate with shroud 208 and rim 204 to facilitate channeling a working fluid 211, such as steam, toward blisk 200, past airfoils 206, and away from blisk 200. Shroud segments 210 facilitate prevention of migration of working fluid 211 radially outwardly from blisk 200 during operation of engine 201, to facilitate increased efficiency of engine 201.

In the exemplary embodiment, blisk 200 is manufactured from a solid circular billet 199 (illustrated in FIG. 2). Billet 199 is forged or cast from any suitable material from which turbine wheels and airfoils are made. Airfoils 206, rim 204, and/or shroud segments 210 are subsequently defined using any suitable material-removal method, including, but not limited to, computer numerical control (“CNC”) milling, electro-chemical machining (“ECM”), and electrical discharge machining (“EDM”). Integrally forming airfoils 206 onto central disk portion 202 facilitates the elimination of dovetail structures that would be susceptible to excess radial loads during turbine operation. In addition, such dovetail structures are often difficult to machine, particularly when superalloys are used.

FIG. 4 is a top perspective view of a portion of turbine blisk 200 illustrated in FIG. 2. In the exemplary embodiment, shroud 208 is initially defined as a continuous ribbon of material coupling all of radially outboard tips 222 (shown in FIG. 3) of airfoils 206 that extends from rim 204 surrounding central disk portion 202. Shroud 208 is then split into separate shroud segments 210, using any suitable cutting or material-removal method that enables blisk 200 to function as described herein. Splitting shroud 208 into separate segments 210 facilitates prevention of excessive hoop and tangential stresses in blisk 200 that would otherwise be encountered during turbine operation.

In the exemplary embodiment, blisk 200 includes an even number of shroud segments 210. In addition, each shroud segment 210 has a span that covers the same amount of arc α (shown in FIG. 2), wherein α is measured in degrees, and is not greater than about 90°. Likewise, a maximum arc α of 90° is provided between adjacent gaps 212, as measured from a gap center 224 to an adjacent gap center 224. In an alternative embodiment, gaps 212 between shroud segments 210 are provided between each pair of adjacent airfoils 206 resulting in a maximum number of shroud segments 210, wherein a minimum arc α is defined by the number of airfoils 206, the dimensions of each airfoil 206, and/or spacing between adjacent airfoils 206. In the exemplary embodiment, the size of arc α is driven by vibration frequency characteristics of blisk 200, which are determined on a case-by-case basis as a function of the physical dimensions and projected operating conditions of each blisk 200. Advantageous placement and spacing of gaps 212 facilitates controlling vibration frequencies of blisk 200 during turbine operation, towards preventing undesirable vibration frequencies.

Exemplary embodiments of a shrouded turbine blisk and method of manufacturing same are described above in detail. The shrouded turbine blisk and methods of manufacturing same are not limited to the specific embodiments described herein, but rather, components of the shrouded turbine blisk and/or steps of the method can be utilized independently and separately from other components and/or steps described herein. For example, the shrouded turbine blisk and methods described herein can also be used in combination with other machines and methods, and are not limited to practice only with steam turbine engines as described herein. Rather, the exemplary embodiments can be implemented and utilized in connection with many other motor and/or turbine applications.

In contrast to known turbine blisk constructions, the shrouded turbine blisk constructions and methods described herein facilitate the sealing of airfoil tips towards prevention of radially outward migration of working fluid therefrom. In addition, the shrouded turbine blisk constructions and methods described herein facilitate an improvement in turbine efficiency. The shrouded turbine blisk constructions and methods described herein also facilitate a reduction in the number of components used in manufacturing a turbine rotor. The shrouded turbine blisk constructions and methods described herein further also facilitate controlling hoop and tangential stresses generated during turbine operation. Moreover, the steam turbine blisk constructions described herein facilitate controlling vibration frequencies encountered during turbine operation.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is formed by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for manufacturing a turbine blisk, said method comprising:
providing a solid circular billet of blisk material;
defining an inner rim, wherein the inner rim extends circumferentially about a central disk portion;
defining a plurality of airfoils, wherein the airfoils extend radially outwardly from the inner rim; and
defining a shroud integrally coupled to each of the plurality of airfoils, wherein the shroud includes a plurality of circumferentially-arranged arcuate shroud segments defined at least in part by gaps defined between adjacent shroud segments.

2. A method in accordance with claim 1, wherein said method comprises defining at least one of the inner rim, the plurality of airfoils and the shroud by removal of blisk material from the billet of blisk material.

3. A method in accordance with claim 2, wherein said method comprises removing blisk material by at least one of computer numerical control milling, electro-chemical machining, and electrical discharge machining

4. A method in accordance with claim 1, wherein defining a plurality of airfoils comprises defining an even number of airfoils uniformly circumferentially-spaced about the inner rim.

5. A method in accordance with claim 1, wherein defining a shroud comprises defining each of the shroud segments to cover a span equal to each other shroud segment span.

6. A method in accordance with claim 5, wherein the constant span is an arc α, wherein α is not greater than about 90°.

7. A method in accordance with claim 1, wherein providing a solid circular billet of blisk material comprises one of forging the billet and casting the billet.

8. A turbine blisk for use in a turbine engine, said turbine blisk comprising:
a central disk portion;
an inner rim that extends circumferentially about said central disk portion;
a plurality of airfoils that extends radially outwardly from said inner rim; and
a shroud integrally coupled to each of said plurality of airfoils, wherein said shroud includes a plurality of circumferentially-arranged arcuate shroud segments defined at least in part by gaps defined between adjacent shroud segments;
wherein said central disk portion, said inner rim, said plurality of airfoils, and said shroud are defined from a single billet of blisk material.

9. A turbine blisk in accordance with claim 8, wherein said plurality of airfoils comprises an even number of airfoils uniformly circumferentially-spaced about the inner rim.

10. A turbine blisk in accordance with claim 8, wherein said plurality of circumferentially-arranged arcuate shroud segments comprises an even number of shroud segments uniformly circumferentially-spaced about the inner rim.

11. A turbine blisk in accordance with claim 8, wherein said airfoils are greater in number than said shroud segments.

12. A turbine blisk in accordance with claim 8, wherein each of said shroud segments covers a span equal to each other shroud segment span.

13. A turbine blisk in accordance with claim 12, wherein the constant span is an arc α, wherein α is not greater than about 90°.

14. A turbine blisk in accordance with claim 8, wherein said solid circular billet of blisk material is fabricated by at least one of forging the billet and casting the billet.

15. A turbine system comprising:
a source of steam;
a steam turbine coupled to said source of steam, wherein said steam turbine includes at least one turbine blisk coupled to an output shaft for rotation about an axis;
a load coupled to said output shaft;
wherein said turbine blisk comprises:
a central disk portion including an axis of rotation;
an inner rim that extends circumferentially about the axis of rotation and encircling said central disk portion;
a plurality of airfoils that extends radially outwardly from said inner rim; and
a shroud integrally coupled to each of said plurality of airfoils, wherein said shroud includes a plurality of circumferentially-arranged arcuate shroud segments defined at least in part by gaps positioned between adjacent shroud segments;
wherein said central disk portion, said inner rim, said plurality of airfoils, and said shroud are defined from a single billet of blisk material.

16. A turbine system in accordance with claim 15, wherein said plurality of airfoils comprises an even number of airfoils uniformly circumferentially-spaced about the inner rim.

17. A turbine system in accordance with claim 15, wherein said plurality of circumferentially-arranged arcuate shroud segments comprises an even number of shroud segments uniformly circumferentially-spaced about the inner rim.

18. A turbine system in accordance with claim 15, wherein said plurality of airfoils is greater than said plurality of shroud segments.

19. A turbine system in accordance with claim 19, wherein the constant span is an arc α, wherein α is not greater than about 90°.

20. A turbine system in accordance with claim 15, wherein said solid circular billet of blisk material is fabricated by at least one of forging the billet and casting the billet.
